(19) United States
(12) Patent Application Publication
(10) Pub. No.: US 2006/0125760 A1
(43) Pub. Date: Jun. 15, 2006

(54) Method of driving a display device, display controller and display device for performing the same

(75) Inventors: Ahn-Ho Jee, Hwaseong-si (KR); Kun-Bin Lee, Suwon-si (KR); Deuk-Soo Kim, Yongin-si (KR); Hyeong-Cheol Ahn, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/298,231

(22) Filed: Dec. 9, 2005

(30) Foreign Application Priority Data
Dec. 11, 2004 (KR) 2004-104555

(51) Int. Cl. G09G 3/36

(52) U.S. Cl. 345/98

(57) ABSTRACT

A method of driving a display device is provided, including storing drive data blocks in a drive data block unit, fetching the drive data blocks from the drive data block unit, storing the drive data blocks in data block setting registers, driving the display device using the drive data blocks stored in the data block setting registers, wherein the drive data blocks contain data used in configuring, controlling, sequencing, setting or initializing the display device.

### CROSS-REFERENCE TO RELATED APPLICATION

This application relies for priority upon Korean Patent Application No. 2004-104555 filed on Dec. 11, 2004, the contents of which are herein incorporated by reference in its entirety.

### BACKGROUND OF THE INVENTION

1. Field of the Invention

The present invention relates to a method of driving a display device, a display controller and a display device for performing the same. More particularly, the present invention relates to a method of driving a display device capable of simplifying software for the display device, a display controller and a display device for performing the same.

2. Description of the Related Art

A conventional active matrix-type display device such as a liquid crystal display apparatus includes one switching element corresponding to each of the display cells.

The active matrix-type display device applies a select voltage to a gate electrode of the switching element to activate a corresponding gate. Then, the active matrix-type display device applies an appropriate analog data voltage to a source electrode of the switching element and charges a selected display cell with a desired voltage level.

The liquid crystal display apparatus includes optimum variable setting data, such as an output voltage or a frame frequency according to a manufacturing method of a liquid crystal panel, a driver IC or parts.

Additionally, display device sets include setting data determined at a development phase of driver software for a display device, such as a number of line inversions, a memory write direction, a booster circuit setting and a mode setting of an amplifier. The setting data described above are stored in a non-volatile memory device included in a liquid crystal display module.

In order to determine the setting data, a controller, such as a main processing unit (MPU) that is separate from the liquid crystal display module, provides a setting command and reads the setting data stored in the non-volatile memory device at an initial stage, such as the start of a system.

That is, a liquid crystal display apparatus is generally operated by setting register data stored in each of the registers from the start register to the last register. For example, in order to maintain a display-off status while system power is on, register data is set to a predetermined value. To set a voltage level before a voltage is boosted, and a voltage level after a voltage is boosted, register data is set to a predetermined value. To perform an initializing sequence, register data are set to each of the predetermined values. In order to perform a display-on sequence, register data are set to each of the predetermined values, and then a display-on status is maintained. The liquid crystal display apparatus is operated by performing a series of operations described above.

The complicated procedure that drives the liquid crystal display apparatus is repeatedly used whenever the liquid crystal display apparatus is turned on.

However, the register data may be set to inappropriate values in some registers due to internal or external considerations while register data setting operations are repeatedly performed. The register data setting error may deteriorate display quality of a display device.

### SUMMARY OF THE INVENTION

An exemplary embodiment of the present invention provides a method of driving a display device capable of reducing abnormal operation of a display driver IC due to external environmental causes.

Another exemplary embodiment of the present invention provides a display controller capable of performing the above method.

Still another exemplary embodiment of the present invention provides a display device capable of performing the above method.

In one aspect of the present invention, a method of driving a display device is provided, including storing drive data blocks in a drive data block unit, fetching the drive data blocks from the drive data block unit, storing the drive data blocks in data block setting registers, driving the display device using the drive data blocks stored in the data block setting registers, wherein the drive data blocks contain data used in configuring, controlling, sequencing, setting or initializing the display device.

The drive data block unit may include a power-on setting data block configured to perform a power-on sequence of the display device, a display setting data block configured to perform a display setting of the display device, a gamma control data block configured to perform a gamma control of the display device, a power-off setting data block configured to perform a power-off sequence of the display device, a standby mode setting data block configured to perform a standby mode setting sequence of the display device, a wake-up mode setting data block configured to perform a wake-up mode setting sequence of the display device, and a row color mode entering/release data block configured to perform a row color mode entering and release sequence of the display device.

The power-on sequence may include setting a first power setting before a power voltage is boosted after the display device is set to a reset and a display-off status from a power-on status, setting a second power setting after the power voltage is boosted after the first power setting is completed, performing an initializing sequence of the display device, and performing a display-on sequence to change the display-off status of the display device into a display-on status after the initializing sequence is completed.

The power-off sequence may include performing a display-off sequence to change a display-on status of the display device into a display-off status, and shutting off a power voltage provided to the display device after the display-off sequence is completed.

The row color mode entering sequence may include performing a display-off sequence to change a display-on status of the display device in a normal color mode into a display-off status, updating data of a graphic random access memory after the display-off sequence is completed, setting a row color mode after the data of the graphic random access memory are updated, performing a display-on sequence to change a display-off status of the display device into a display-on status after the row color mode is completed, and altering register data of the display-on status to change the display-on status of the display device into a display-on status of a row color mode of the display device after the display-on sequence is completed.

The row color mode release sequence may include performing a display-off sequence to change a display-on status of the display device in the row color mode into a display-off status, updating data of a graphic random access memory after the display-off sequence is completed, setting a normal color mode after the data of the graphic random access memory are updated, performing a display-on sequence to change the display-off status of the display device into the display-on status after the normal color mode is completed, and altering register data of the display-on status to change the display-on status into a display-on status of a normal color mode of the display device after the display-on sequence is completed.

The standby mode setting sequence may include performing a display-off sequence to change a display-on status of the display device into a display-off status of the display device, and altering register data of the display-on status to perform a standby mode setting operation after the display-off sequence is completed.

The wake-up mode setting sequence may include starting an oscillation sequence from the standby mode of the display device, canceling the standby mode after the oscillation sequence starts, and performing a power-on sequence to change the oscillation sequence of the display device into a display-on status after the standby mode is canceled.

In another aspect of the present invention, a display device display controller has a program receiver, a data block setting register unit and a chip controller. The program receiver is coupled with a host system. The data block setting register unit is coupled with the program receiver, and stores drive data blocks used to drive the display device. The chip controller controls driving of the display device by fetching a corresponding drive data block from the data block setting register unit in response to an image signal and a control signal corresponding to the image signal provided from the host system.

The display controller may include a display data output circuit, a source controller and a gate controller. The display data output circuit outputs a display data signal received from the host system to a source driver of the display device. The source controller outputs a timing signal and a control signal received from the chip controller to the source driver of the display device. The gate controller outputs the timing signal and the control signal received from the chip controller to a gate driver of the display device.

In still another aspect of the present invention, in a display device the display device includes a display panel, a source driver, a gate driver, a memory and a display controller. The source driver provides a data signal to a data line of the display panel. The gate driver provides a gate signal to a gate line of the display panel. The memory stores drive data blocks used to drive the display device. The display controller stores drive data blocks used to drive the display device in a drive data block unit and controls driving of the source driver and the gate driver by fetching the drive data blocks from the drive data block unit in response to an image signal and a control signal corresponding to the image signal provided from a host system.

The display controller may include a program receiver coupled with the host system and the memory, and a data block setting register unit coupled with the program receiver. The data block setting register unit stores drive data blocks used to drive the display device in the drive data block unit.

The data block setting register unit may include a plurality of data block setting registers. The data block selling registers have a locking function that protects the drive data block unit.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating a liquid crystal display apparatus according to an exemplary embodiment of the present invention;

FIG. 2 is a block diagram illustrating the display controller of the liquid crystal display apparatus of FIG. 1;

FIG. 3 is a block diagram illustrating input/output operations of the source driver of FIG. 1;

FIG. 4 is a block diagram illustrating a data block setting register u nit included in the programmable register of FIG. 2;

FIG. 5 is a flowchart illustrating the power-on sequence of FIG. 4;

FIG. 6 is an address allocation table illustrating the display-off status of FIG. 5;

FIG. 7 is a flowchart illustrating the first/second power setting sequence of FIG. 5;

FIG. 8 is an address allocation table illustrating the initializing sequence of FIG. 5;

FIG. 9 is a block diagram illustrating a configuration of a gamma voltage generator performed based on the gamma control data block of FIG. 4;

FIG. 10 is a flowchart illustrating the power-off sequence of FIG. 4;

FIGS. 11A and 11B are flowcharts illustrating an 8-color mode entering sequence of FIG. 4;

FIGS. 12A and 12B are flowcharts illustrating an 8-color mode release sequence of FIG. 4;

FIG. 13 is a flowchart illustrating a standby mode sequence of FIG. 4; and

FIG. 14 is a flowchart illustrating a wake-up mode sequence of FIG. 4.

### DESCRIPTION OF THE EMBODIMENTS

Hereinafter, the present invention will be explained in detail with reference to the accompanying drawings.

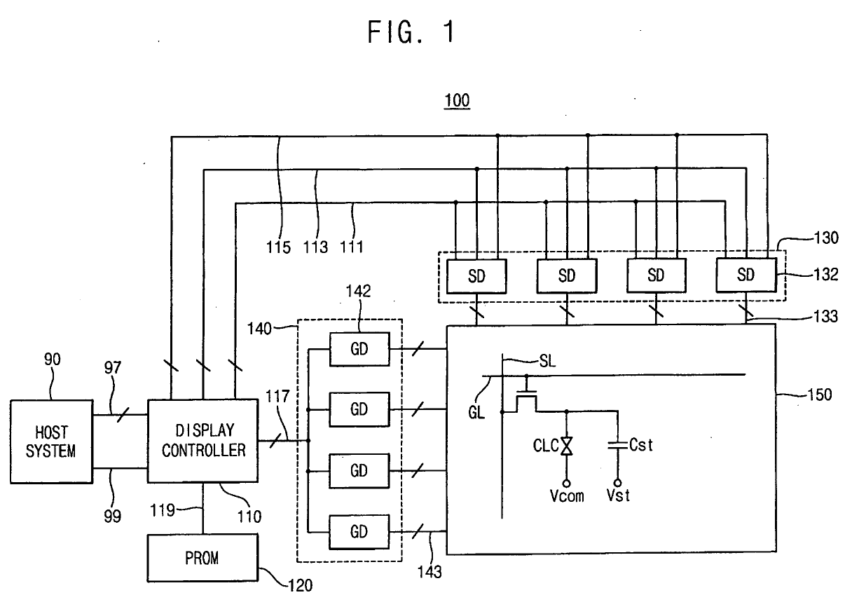

FIG. 1 is a block diagram illustrating a liquid crystal display apparatus according to an exemplary embodiment of the present invention.

Referring to FIG. 1, the liquid crystal display apparatus 100 includes a display controller 110, a programmable read-only memory (PROM) 120, a source driver 130, a gate driver 140 and a liquid crystal display panel 150.

Display data and synchronizing signals are provided to the display controller 110 via display controller d/s lines 97 from a host system 90 such as an external computer system, a television or a video system.

The display controller 110 provides a source control signal via source control lines 113 and display data via display data lines 115 to the source driver 130, and the source driver 130 is electrically coupled with source electrodes of the liquid crystal display panel 150 via source electrode lines 133.

The liquid crystal display panel 150 includes a plurality of gate lines GL, a plurality of source lines SL and a plurality of thin film transistors TFT electrically coupled with the gate lines GL and the source lines SL. The gate lines GL transfer gate signals to the TFT, and the source lines SL transfer display data signals to the TFT. Drain electrodes of the TFT are commonly coupled with liquid crystal capacitors Clc and storage capacitors Cst.

The display controller 110 provides a control signal to the gate driver 140 coupled with gate electrodes of the liquid crystal display panel 150 via gate electrode lines 143 and gate control lines 117.

The display controller 110 drives the source driver 130 by providing a programmable analog reference signal to the source driver 130 via reference signal lines 111. The programmable analog reference signal, the source control signal and the gate control signal from the display controller 110 are programmed by the PROM 120, which is outside of the liquid crystal display apparatus 100 via a first serial bus 119 during the initial stage. The first serial bus 119 may include an I²C bus. Programmability of an output of the display controller 110 accomplished by the external PROM 120 provides flexibility in order that the display controller 110 may be operable in a different display system without redesigning the display controller 110 based on particular characteristics corresponding to the different display system.

The display controller 110 communicates with the host system 90 via a second serial bus 99. A software program executed in the host system 90 is capable of dynamically modifying the programmable analog reference signal, the source control signal and the gate control signal output from the display controller 110. The first serial bus 119 and the second serial bus 99 may be separate from each other or may be identical to each other. The display controller 110 is capable of controlling operational characteristics of the display device, according to a particular application, and of compensating for some environmental variations, since the output of the display controller 110 may be dynamically modified using the software program of the host system 90.

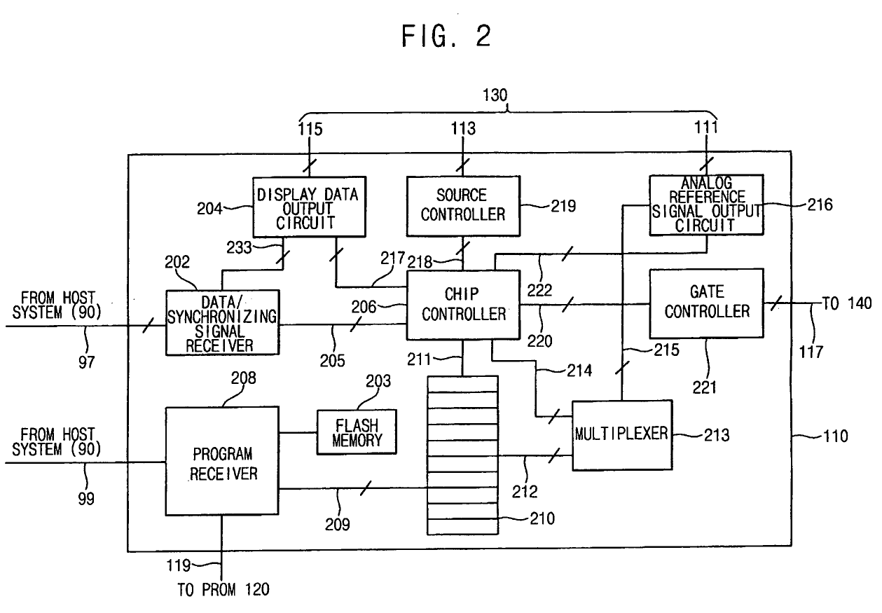

FIG. 2 is a block diagram illustrating the display controller of the liquid crystal display apparatus of FIG. 1.

Referring to FIG. 2, the display controller 110 includes a data/synchronizing signal receiver 202, a display data output circuit 204, a chip controller 206, a program receiver 208, a programmable register 210, a multiplexer 213, a source controller 219, a gate controller 221, an analog reference signal output circuit 216 and a flash memory 203.

In an exemplary embodiment, the display controller 110 may be implemented on one chip. The elements of the display controller 110 are separately described in logical terms for ease of understanding, whether or not they are separate physical hardware elements.

The data/synchronizing signal receiver 202 receives display data and synchronizing signals from the host system 90 via the display controller d/s lines 97. The data/synchronizing signal receiver 202 is coupled with the display data output circuit 204 via display data d/s lines 233, and coupled with the chip controller 206 via chip controller d/s lines 205.

The program receiver 208 receives a first drive data block from the external PROM 120 via the first serial bus 119, and receives a second drive data block from the host system 90 via the second serial bus 99. The program receiver 208 is coupled with the programmable register 210 via first register lines 209. Additionally, the program receiver 208 may receive a third drive data block from the flash memory 203.

The programmable register 210 is coupled with the chip controller 206 via second register lines 211, and coupled with the multiplexer 213 via first multiplexer lines 212. The multiplexer 213 is coupled with the chip controller 206 via second multiplexer lines 214, and coupled with the analog reference signal output circuit 216 via multiplexer output lines 215.

The chip controller 206 controls drive of the display device by fetching every drive data block from the programmable register 210 using an image signal and a control signal corresponding to the image signal provided from the host system 90.

More particularly, the chip controller 206 receives a data/synchronizing signal from the data/synchronizing signal receiver 202 via the chip controller d/s lines 205, and receives a corresponding drive data block from the programmable register 210 via the second register line 211. The chip controller 206 outputs a timing signal and a control signal to the display data output circuit 204 via display data t/c lines 217, to the source controller 219 via source controller t/c lines 218, to the gate controller 221 via gate controller t/c lines 220 and to the analog reference signal output circuit 216 via analog reference t/c lines 222.

The display data output circuit 204 receives a display data signal from the data/synchronizing signal receiver 202 via the display data d/s lines 233, and receives a timing signal and a control signal from the chip controller 206 via the display data t/c lines 217. The display data output circuit 204 outputs the display data signal to the source driver 130 via the display data lines 115.

The source controller 219 receives a timing signal and a control signal from the chip controller 206 via the source controller t/c lines 218. The source controller 219 outputs the timing signal and the control signal to the source driver 130 via the source control lines 113.

The gate controller 221 receives a timing signal and a control signal from the chip controller 206 via the gate controller t/c lines 220. The gate controller 221 outputs the timing signal and the control signal to the gate driver 140 via the gate control lines 117.

The analog reference signal output circuit 216 receives a timing signal and a control signal from the chip controller 206 via the analog reference t/c lines 222, and receives a fourth drive data block from the multiplexer 213 via the multiplexer output lines 215. The analog reference signal output circuit 216 outputs an analog reference signal to the source driver 130 via the reference signal lines 111.

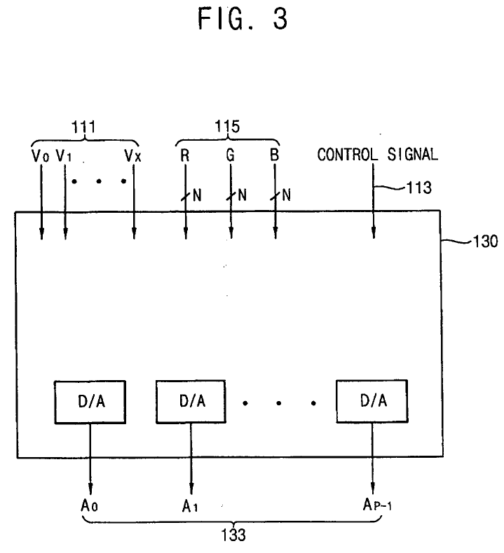

FIG. 3 is a block diagram illustrating input/output operations of the source driver of FIG. 1.

Referring to FIG. 3, the source driver 130 receives X analog reference signals V₀, V₁, . . . , V_{X-1} via the reference signal lines 111, receives the display data via the display data lines 115, and receives the timing signal and the control signal via the source control lines 113.

The source driver 130 outputs a plurality of P analog voltage signals applied to a source electrode of the liquid crystal display panel 150 via the source electrode lines 133. In detail, n-bits of display data are latched to be converted to one of the P analog voltage signals by an digital-to-analog (D/A) converter using the X analog reference signals, and then, the converted analog voltage signal is applied to the source electrode of the liquid crystal display panel 150. In a converting process, the X analog reference signals are typically used to approach a non-linear transmission line (or a gamma line) of a liquid crystal display apparatus.

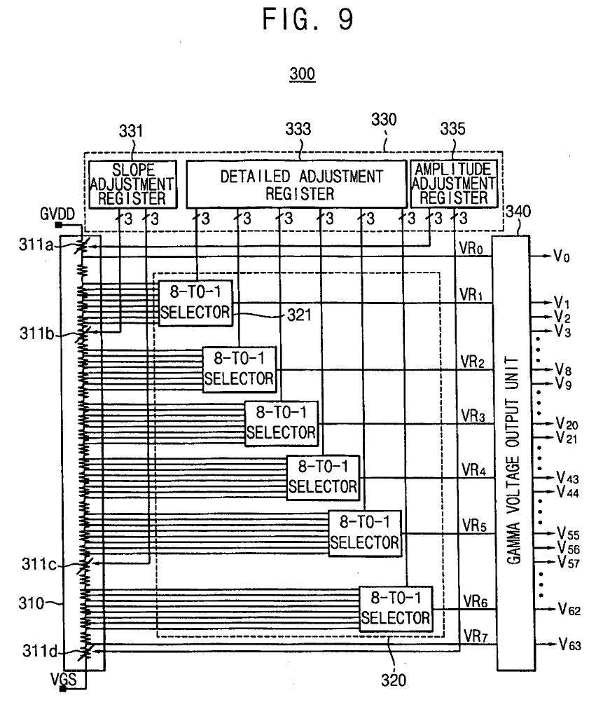

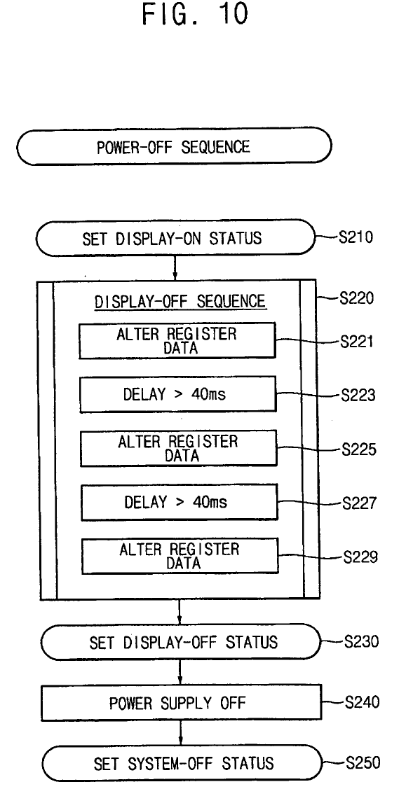

The digital-to-analog (D/A) converter outputs the converted analog voltage signal based on a gamma voltage signal provided from an external gamma voltage generator (refer to FIG. 9) to source electrodes of the liquid crystal display panel 150. The external gamma voltage generator will be explained in detail with reference to FIG. 9.

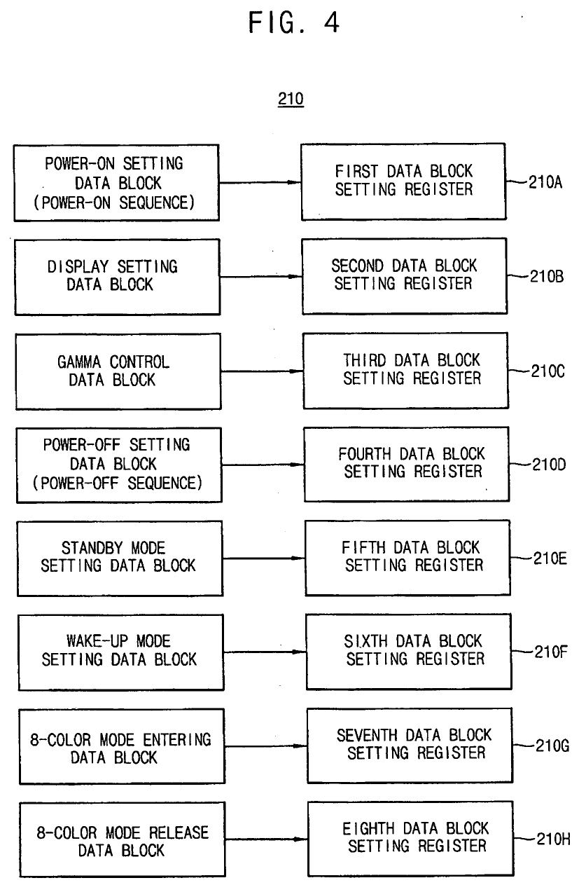

FIG. 4 is a block diagram illustrating a data block setting register unit included in the programmable register of FIG. 2.

Referring to FIG. 4, a block setting register unit included in the programmable register 210 according to an exemplary embodiment of the present invention includes first, second, third, fourth, fifth, sixth, seventh and eighth data block setting registers 210A, 210B, 210C, 210D, 210E, 210F, 210G and 210H. In the present embodiment, the data block setting register unit is separately described in logical terms for ease of understanding and may not be a separate physical hardware device.

The first data block setting register 210A stores a power-on setting data block for a power-on sequence. The second data block setting register 210B stores a display setting data block for a display setting operation. The third data block setting register 210C stores a gamma control data block for a gamma control operation. The fourth data block setting register 210D stores a power-off setting data block for a power-off sequence.

The fifth data block setting register 210E stores a standby mode setting data block for a standby mode setting operation. The sixth data block setting register 210F stores a wake-up mode setting data block for a wake-up mode setting operation.

The seventh data block setting register 210G stores an 8-color mode entering data block for an 8-color mode entering operation. The eighth data block setting register 210H stores an 8-color mode release data block for an 8-color mode release operation.

As a corresponding data block is set to each of the data block setting registers, the display device may utilize one corresponding data block employed for a display operation during drive time. Accordingly, the register data may be precluded from being set to inappropriate values in some registers due to internal or external considerations for the display device, for example the display quality of the display device may be precluded from being deteriorated.

When modification or manipulation of a data block stored in a particular data block setting register is required, a manufacturer of a display device may easily modify the sequence by performing a reset, update or modification operation on a data block setting register storing a corresponding data block.

In addition, as characteristics of the display device are changed, additional sequences may be stored in separate registers, for example when a sequence for supporting a video mode such as MPEG-4 or when a sequence for supporting a three-dimensional image are required.

The exemplary embodiments of the present invention described above will be explained in detail, below. Addresses of various registers described here may be understood collectively as an exemplary embodiment, and register data may be understood collectively as an exemplary embodiment. The register addresses and register data may be altered based on corresponding characteristics of the display device when applications, related specifications and employed driver ICs of the display device are changed.

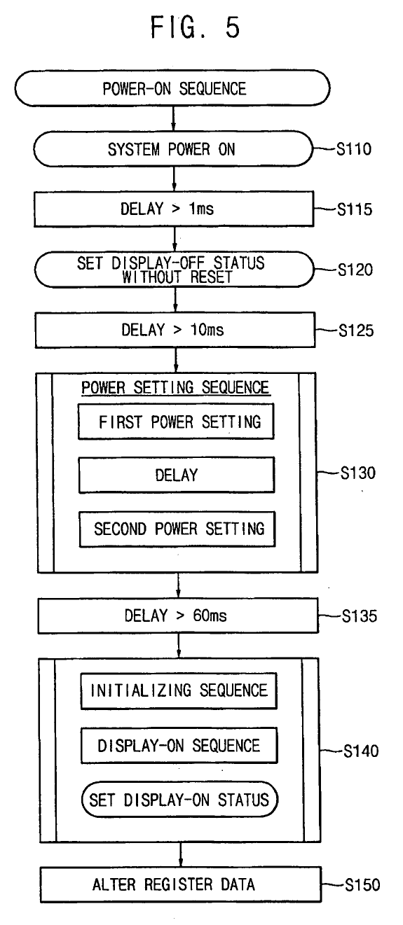

FIG. 5 is a flowchart illustrating the power-on sequence of FIG. 4.

Referring to FIG. 5, system power is turned on S110. After a delay of about one millisecond S115, a reset operation is not performed and a display-off status is set S120.

Next, after a delay of about ten milliseconds S125, a power setting sequence is performed S130. The power setting sequence includes a first power setting step followed by a predetermined delay and a second power setting step. The first power setting step converts a voltage provided from an external power source to a first power supply voltage before the first power supply voltage is boosted. The second power setting step boosts the first power supply voltage and converts the boosted first power supply voltage to a second power supply voltage. The register data performing the power setting sequence are stored in the first data block setting register 210A.

After a delay of about sixty milliseconds S135, a display setting sequence is performed setting a display-on status S140, then register data stored in the first data block setting register 210A is altered S150. The display setting sequence includes a first step that performs an initializing sequence, a second step that performs a display-on sequence and a third step that sets a display-on status. The display setting sequence is stored in the second data block setting register 210B.

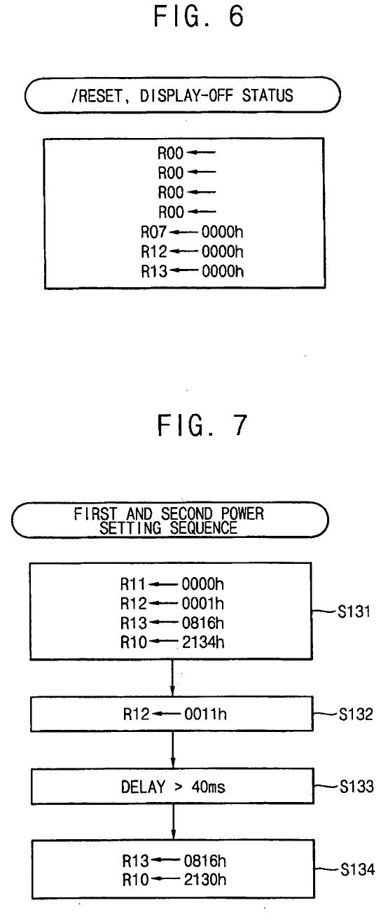

FIG. 6 is an address allocation table illustrating the display-off status of FIG. 5.

Referring to FIG. 6, register R07 is set to ‘0000h’, register R12 is set to ‘0000h’ and register R13 is set to ‘0000h’. As a result, the reset operation is not performed and the display-off status is set.

FIG. 7 is a flowchart illustrating the first and second power setting sequence of FIG. 5.

Referring to FIG. 7, register R11 is set to ‘0000h’, register R12 is set to ‘0001h’, register R13 is set to ‘0816h’ and register R10 is set to ‘2134h’ S131.

Next, register R12 is set to ‘0011h’ S132.

After a delay of about forty milliseconds S133, register R13 is set to ‘0816h’and register R10 is set to ‘2130h’ S134. According to the series of processes described above, the first power setting is set by converting a voltage provided from an external power source to the first power supply voltage before the first power supply voltage is boosted. The second power setting is set by boosting the first power supply voltage to convert the boosted first power supply voltage to the second power supply voltage.

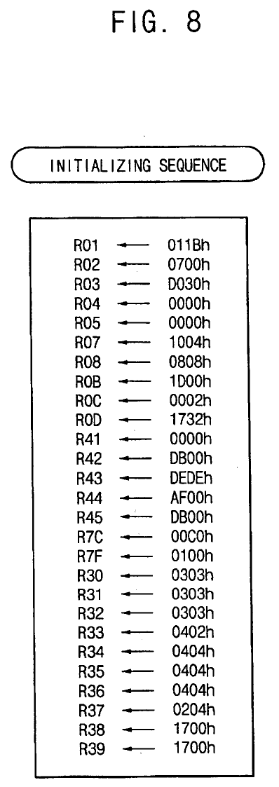

FIG. 8 is an address allocation table illustrating the initializing sequence of FIG. 5.

Referring to FIG. 8, register R01 is set to ‘011Bh’, register R02 is set to ‘0700h’, register R03 is set to ‘D030h’, register R04 is set to ‘0000h’, register R05 is set to ‘0000h’, register R07 is set to ‘1004h’ and register R08 is set to ‘0808h’.

Register R08 is set to ‘1D00h’, register ROC is set to ‘0002h’, register ROD is set to ‘1732h’, register R41 is set to ‘0000h’, register R42 is set to ‘DB00h’, register R43 is set to ‘DEDEh’, register R44 is set to ‘AF00h’ and register R45 is set to ‘DB00h’.

Register R7C is set to ‘00C0h’ and register R7F is set to ‘0100h’.

Register R30 is set to ‘0303h’, register R31 is set to ‘0303h’, register R32 is set to ‘0303h’, register R33 is set to ‘0402h’, register R34 is set to ‘0404h’, register R35 is set to ‘0404h’, register R36 is set to ‘0404h’, register R37 is set to ‘0204h’, register R38 is set to ‘1700h’ and register R39 is set to ‘1700h’.

The register data of registers R30 through R39 described above may be stored in the third data block setting register 210C.

FIG. 9 is a block diagram illustrating a configuration of a gamma voltage generator operated based on the gamma control data block of FIG. 4.

Referring to FIG. 9, a gamma voltage generator 300 includes a gamma reference voltage generating unit 310, a gamma voltage selection unit 320, a gamma adjusting register unit 330 and a gamma voltage output unit 340.

The gamma reference voltage generating unit 310 includes a plurality of resistor arrays serially coupled between a gamma voltage GVDD and a ground voltage VGS, and generates a gamma reference voltage according to voltage levels derived by dividing each voltage of the resistors. The resistor arrays include first, second, third and fourth variable resistors 311a, 311b, 311c and 311d in addition to resistors for dividing voltage. According to alternative embodiments, the first and second variable resistors 311a and 311b or the third and fourth variable resistors 311c and 311d may include a plurality of variable resistors, respectively.

The gamma voltage selection unit 320 includes a plurality of selectors 321, and selects the gamma reference voltage output from the resistor arrays in response to register data provided from the gamma adjusting register unit 330 to provide the selected gamma reference voltage VR₀ to VR₇ to the gamma voltage output unit 340.

The gamma adjusting register unit 330 includes a slope adjustment register 331, a detailed adjustment register 333 and an amplitude adjustment register 335, and outputs a plurality of register data for selecting a gamma reference voltage to the gamma reference voltage generating unit 310 and the gamma voltage selection unit 320.

More particularly, the slope adjustment register 331 stores register data to adjust a slope of a gamma line, the detailed adjustment register 333 stores register data to adjust the gamma line in detail and the amplitude adjustment register 335 stores register data to adjust an amplitude of the gamma line. The gamma reference voltage generating unit 310 provides register data for adjusting the slope and amplitude of the gamma line. The register data that adjust the slope and amplitude of the gamma line are provided to the gamma reference voltage generating unit 310, and register data that adjust the gamma line in detail are provided to the gamma voltage selection unit 320.

The gamma voltage output unit 340 outputs a plurality of gamma voltages V₀ to V₆₃ based on a first gamma reference voltage provided from the gamma reference voltage generating unit 310 and based on a second gamma reference voltage provided from the gamma voltage selection unit 320. The plurality of gamma voltages is provided to a digital-to-analog (D/A) converter included in the source driver 130.

FIG. 10 is a flowchart illustrating the power-off sequence of FIG. 4.

Referring to FIG. 10, after a display device is turned on S210, a display-off sequence is performed S220.

In the display-off sequence, register R07 is set to ‘0036h’ S221. After a delay of about forty milliseconds S223, register R07 is set to ‘0026h’ S225. After a delay of about forty milliseconds S227, register R07 is set to ‘0004h’S229.

As the display-off sequence is completed, the display-off status is set S230, and register data are set to specified values to perform the power-off sequence S240. Therefore, registers R10, R12, and R13 are set to ‘0000h’.

As register data are set to specified data to perform the power-off sequence, a system-off status is set since system power provided from an external source is shut off S250.

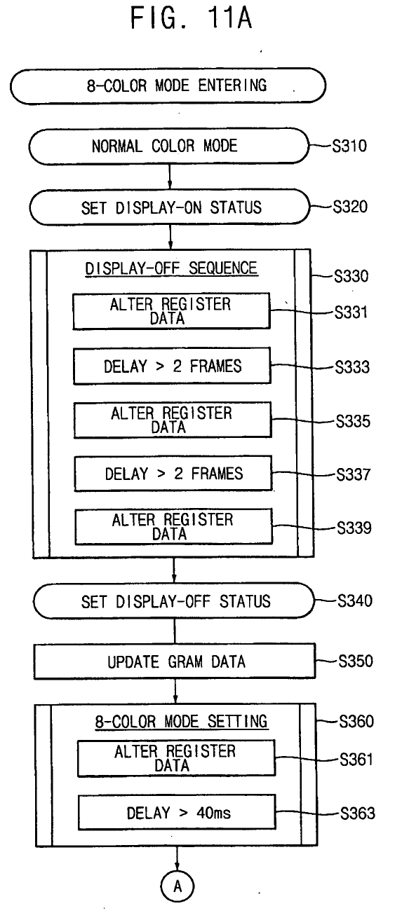

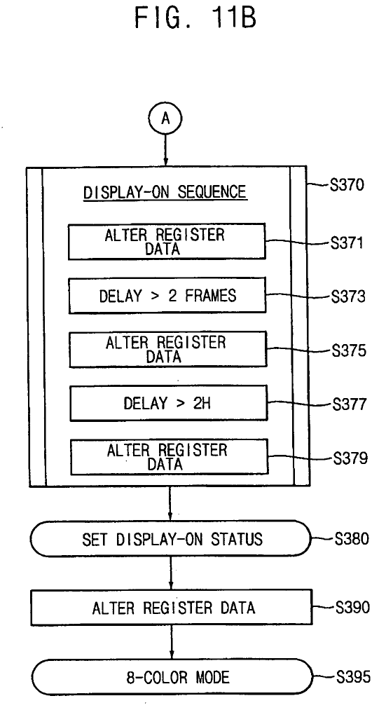

FIGS. 11A and 11B are flowcharts illustrating an 8-color mode entering sequence of FIG. 4. The 8-color mode entering data block is stored in a seventh data block setting register 210G.

Referring to FIGS. 11A and 11B, in a normal color mode (or high color mode) such as a 260,000-color mode S310, as a display device sets the display-on status S320, a display-off sequence of the display device is performed S330. In the display-off sequence S330, the register R07 is set to ‘0036h’ S331. After a delay of about the duration of two frames S333, register R07 is set to ‘0026h’ S335. After a delay of about the duration of two frames S337, register R07 is set to ‘0004h’ S339.

As the display-off sequence is completed, the display device is set to the display-off status S340.

Then, data stored in a graphic random access memory GRAM are updated S350.

Next, an 8-color mode setting operation is performed S360. In the 8-color mode setting operation, register R07 is set to ‘0000Ch’ S361, and a delay of about forty milliseconds is included S363.

Now to set the display-on status, the display-on sequence is performed S370. In the display-on sequence S370, register R07 is set to ‘000Dh’ S371. After a delay of about the duration of two frames S373, register R07 is set to ‘002Fh’ S375. After a delay of about the duration of two horizontal lines S377, register R07 is set to ‘003Fh’ S379.

As the display-on sequence is completed, the display device is set to the display-on status S380, and register R21 is set to ‘0000h’ S390. Finally, the display device enters into the 8-color mode S395.

In alternative embodiments, a color mode entering sequence having a smaller color number than 260,000 colors may be applied to a display device.

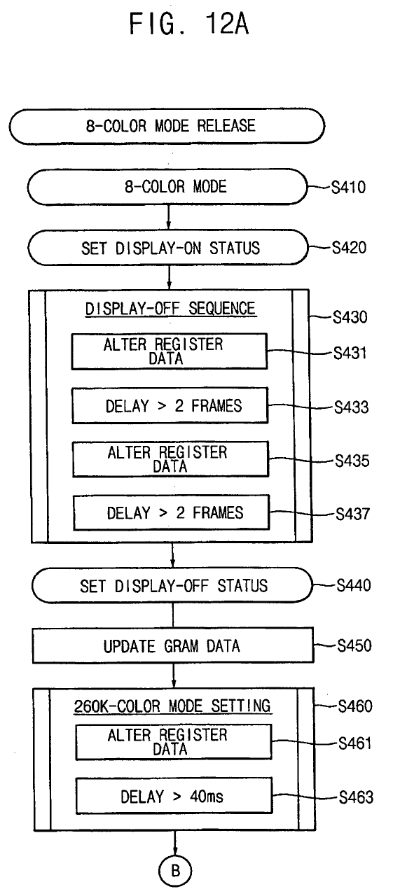

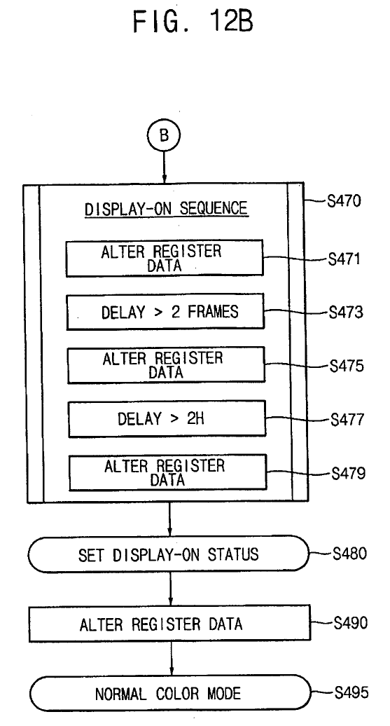

FIGS. 12A and 12B are flowcharts illustrating an 8-color mode release sequence of FIG. 4. The 8-color mode release data block is stored in an eighth data block setting register 210H.

Referring to FIGS. 12A and 12B, in the 8-color mode S410, as a display device sets the display-on status S420, a display-off sequence of the display device is performed S430.

In the display-off sequence S430, register R07 is set to ‘003Eh’ S431. After a delay of about the duration of two frames S433, register R07 is set to ‘002Eh’ S435. After a delay of about the duration of two frames S437, register R07 is set to ‘0000Ch’ S439.

As the display-off sequence is completed, the display device sets the display-off status S440.

Next, data stored in a graphic random access memory GRAM is updated S450. Then a normal mode setting operation such as a 260,000-color mode setting operation is performed S460. In the 260,000-color mode setting operation, register R07 is set to ‘0004h’ S461. A delay of about forty milliseconds is included S463.

Next, to set the display-on status, the display-on sequence is performed S470. In the display-on sequence S470, register R07 is set to ‘0005h’ S471. After a delay of about the duration of two frames S473, register R07 is set to ‘0027h’ S475. After about the duration of two horizontal lines S477, register R07 is set to ‘0037h’ S479.

As the display-on sequence is completed, the display device sets the display-on status S480, and register R21 is set to ‘0000h’ S490. Finally, the display device enters into the normal mode S495.

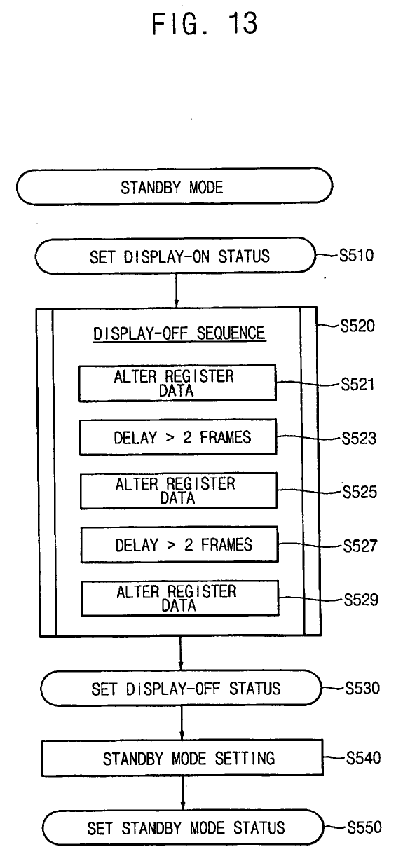

FIG. 13 is a flowchart illustrating a standby mode sequence of FIG. 4. The standby mode sequence is stored in a fifth data block setting register 210E.

Referring to FIG. 13, in a display-on status of the display device S510, a display-off sequence of the display device is performed S520. In the display-off sequence S520, register R07 is set to ‘0036h’ S521. After a delay of about the duration of two frames S523, register R07 is set to ‘0026h’ S525. After a delay of about the duration of two frames S527, register R07 is set to ‘0004h’S529.

As the display-off sequence is completed, the display device sets the display-off status S530.

Next, register R10 is set to ‘0001h’ to be in a standby mode S540. As a result, the display device sets a standby mode status S550.

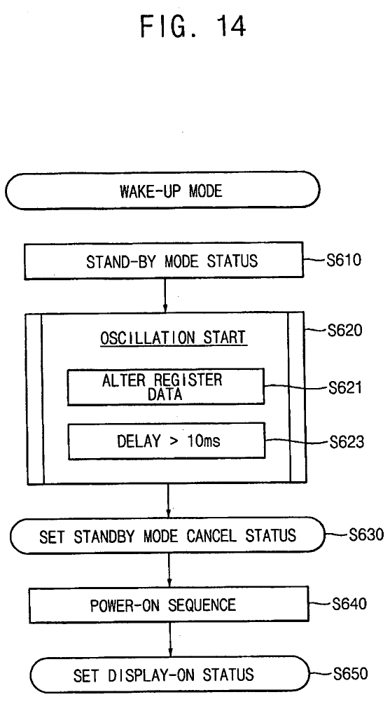

FIG. 14 is a flowchart illustrating a wake-up mode sequence of FIG. 4.

Referring to FIG. 14, in the standby mode status of the display device S610, an oscillation sequence that cancels the standby mode of the display device is performed S620. In the oscillation sequence S620, register R00 is set to ‘0001 h’ S621. A delay of about ten milliseconds is included S623.

As the oscillation sequence is completed, the display device sets a standby mode cancel status S630. Next, a power-on sequence is performed S640. As the power-on sequence is completed, the display device sets the display-on status S650.

According to exemplary embodiments of the present invention, setting data that drive the display device may be set using the drive data blocks, and users needing a specific data block may manipulate the specific data block in question.

Additionally, an abnormal operation of the driver IC due to external environmental considerations such as system noise may be reduced.

Furthermore, an abnormal setting of the system may be precluded since a locking function on a data block setting register unit is provided.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A method of driving a display device, comprising:
storing drive data blocks in a drive data block unit;
fetching the drive data blocks from the drive data block unit;
storing the drive data blocks in data block setting registers; and
driving the display device using the drive data blocks stored in the data block setting registers, wherein the drive data blocks contain data used in configuring, controlling, sequencing, setting or initializing the display device.

2. The method of claim 1, wherein the drive data block unit comprises:
a power-on setting data block configured to perform a power-on sequence of the display device;
a display setting data block configured to perform a display setting of the display device;
a gamma control data block configured to perform a gamma control of the display device;
a power-off setting data block configured to perform a power-off sequence of the display device;
a standby mode setting data block configured to perform a standby mode setting sequence of the display device;
a wake-up mode setting data block configured to perform a wake-up mode setting sequence of the display device; and
a row color mode entering/release data block configured to perform a row color mode entering and release sequence of the display device.

3. The method of claim 2, wherein the power-on sequence comprises:
setting a first power setting before a power voltage is boosted after the display device is set to a reset and a display-off status from a power-on status;
setting a second power setting after the power voltage is boosted after the first power setting is completed;
performing an initializing sequence of the display device; and
performing a display-on sequence to change the display-off status of the display device into a display-on status after the initializing sequence is completed.

4. The method of claim 2, wherein the power-off sequence comprises:
performing a display-off sequence to change a display-on status of the display device into a display-off status; and
shutting off a power voltage provided to the display device after the display-off sequence is completed.

5. The method of claim 2, wherein the row color mode entering sequence comprises:
performing a display-off sequence to change a display-on status of the display device in a normal color mode into a display-off status;
updating data of a graphic random access memory after the display-off sequence is completed;
setting a row color mode after the data of the graphic random access memory are updated;
performing a display-on sequence to change a display-off status of the display device into a display-on status after the row color mode is completed; and
altering register data of the display-on status to change the display-on status of the display device into a display-on status of a row color mode of the display device after the display-on sequence is completed.

6. The method of claim 2, wherein the row color mode release sequence comprises:
performing a display-off sequence to change a display-on status of the display device in the row color mode into a display-off status;
updating data of a graphic random access memory after the display-off sequence is completed;
setting a normal color mode after the data of the graphic random access memory are updated;
performing a display-on sequence to change the display-off status of the display device into the display-on status after the normal color mode is completed; and
altering register data of the display-on status to change the display-on status into a display-on status of a normal color m ode of the display device after the display-on sequence is completed.

7. The method of claim 2, wherein the standby mode setting sequence comprises:
performing a display-off sequence to change a display-on status of the display device into a display-off status of the display device; and
altering register data of the display-on status to perform a standby mode setting operation after the display-off sequence is completed.

8. The method of claim 2, wherein the wake-up mode setting sequence comprises:
starting an oscillation sequence from the standby mode of the display device;
canceling the standby mode after the oscillation sequence starts; and
performing a power-on sequence to change the oscillation sequence of the display device into a display-on status after the standby mode is canceled.

9. A display device display controller, comprising:
a program receiver coupled with a host system;
a data block setting register unit coupled with the program receiver, and configured to store drive data blocks used to drive the display device; and
a chip controller configured to control driving of the display device by fetching a corresponding drive data block from the data block setting register unit in response to an image signal and a control signal corresponding to the image signal provided from the host system.

10. The display device display controller of claim 9, wherein the data block setting register unit comprises a plurality of data block setting registers, and the data block setting registers have a locking function that protects a drive data block unit.

11. The display device display controller of claim 9, wherein the data block setting register unit comprises:
a first data block setting register configured to store a power-on setting data block for a power-on sequence of the display device;
a second data block setting register configured to store a display setting data block for a display setting of the display device;
a third data block setting register configured to store a gamma control data block for a gamma control of the display device;
a fourth data block setting register configured to store a power-off setting data block for a power-off sequence of the display device; and
a fifth data block setting register configured to store a standby mode setting data block for a standby mode setting sequence of the display device.

12. The display device display controller of claim 11, wherein the data block setting register unit further comprises a sixth data block setting register configured to store a wake-up mode setting data block for a wake-up mode setting sequence of the display device.

13. The display device display controller of claim 11, wherein the data block setting register unit further comprises a seventh data block setting register configured to store a row color mode entering data block for a row color mode entering sequence of the display device.

14. The display device display controller of claim 11, wherein the data block setting register unit further comprises an eighth data block setting register configured to store a row color mode release data block for a row color mode release sequence of the display device.

15. The display device display controller of claim 9, further comprising:
a display data output circuit configured to output a display data signal received from the host system to a source driver of the display device;
a source controller configured to output a timing signal and a control signal received from the chip controller to the source driver of the display device; and
a gate controller configured to output the timing signal and the control signal received from the chip controller to a gate driver of the display device.

16. A display device, comprising:
a display panel;
a source driver configured to provide a data signal to a data line of the display panel;
a gate driver configured to provide a gate signal to a gate line of the display panel;
a memory configured to store drive data blocks used to drive the display device; and
a display controller configured to store the drive data blocks used to drive the display device in a drive data block unit and configured to control driving of the source driver and the gate driver by fetching the drive data blocks from the drive data block unit in response to an image signal and a control signal corresponding to the image signal provided from a host system.

17. The display device of claim 16, wherein the display controller comprises a program receiver coupled with the host system and the memory, a data block setting register unit coupled with the program receiver, and the data block setting register unit stores drive data blocks used to drive the display device in the drive data block unit.

18. The display device of claim 17, wherein the data block setting register unit comprises a plurality of data block setting registers, and the data block setting registers have a locking function that protects the drive data block unit.

19. The display device of claim 17, wherein the data block setting register unit comprises:
a first data block setting register configured to store a power-on setting data block for a power-on sequence of the display device;
a second data block setting register configured to store a display setting data block for a display setting of the display device;
a third data block setting register configured to store a gamma control data block for a gamma control of the display device;
a fourth data block setting register configured to store a power-off setting data block for a power-off sequence of the display device; and
a fifth data block setting register configured to store a standby mode setting data block for a standby mode setting sequence of the display device.

20. The display device of claim 16, wherein the display panel comprises:
a liquid crystal display panel having a thin film transistor (TFT) electrically coupled with the gate line and the source line of the display panel;
a liquid crystal capacitor electrically coupled with the TFT; and
a storage capacitor electrically coupled with the TFT.
